(19) United States
(12) Patent Application Publication
(10) Pub. No.: US 2013/0171313 A1
(43) Pub. Date: Jul. 4, 2013

(54) PRODUCTION OF GELATIN-CONTAINING CONFECTIONERY

(71) Applicant: Alois Thelen, Baesweiler (DE)

(72) Inventor: Alois Thelen, Baesweiler (DE)

(21) Appl. No.: 13/806,303

(22) PCT Filed: Jun. 24, 2011
(86) PCT No.: PCT/EP2011/003107

§ 371 Date: Jan. 14, 2013

(30) Foreign Application Priority Data
Jun. 23, 2010 (DE) 102010024828.2

(51) Int. Cl. A23G 3/44

(52) U.S. Cl. CPC A23G 3/44
USPC 426/519; 426/520

(57) ABSTRACT

The present invention provides an improved process for production of gelatin-containing confectionery, in which a mass composed of starch and syrup is liquefied at low temperature and admixed with a gelatin solution.

The present invention relates to an improved process for the production of gelatin-containing confectionery, in which a mass composed of starch and syrup is liquefied at a low temperature and admixed with a gelatin solution.

### BACKGROUND

The production of gelatin-containing confectionery requires intense heating or boiling of the sugar/starch component for preparing the necessary sugar/starch solution. The solution obtained cannot be admixed with the dissolved gelatin before it has been cooled down to about 50 to 70° C., and after the two solutions are combined, another cooling to room temperature or below is required to solidify the confectionery. Thus, these cooling steps require a significant amount of time (up to 24 h), which has an impact on the production cost. Therefore, a priority object in confectionery production is to shorten the cooling process.

### SUMMARY OF THE INVENTION

It has now been found that significantly lower temperatures than those used in a conventional process can be employed if the base material of starch and syrup as known from WO07/63034 is liquefied and the gelatin solution is subsequently added, and thus the cooling times can be shortened significantly. Thus, the present invention relates to a process for the production of gelatin-containing confectionery, comprising:

(a) liquefying a base material essentially consisting of a starch flour or a mixture of several starch flours and a syrup or a mixture of several syrups, by heating;

(b) adding a heated and liquefied gelatin and mixing; and

(c) cooling the mixture obtained to solidify.

Thus, confectionery such as wine gum and fruit gum articles having a high or very high gelatin content could be prepared via a novel, previously unknown liquid mass. In the process according to the invention, a separate sugar adding step can be dispensed with completely, so that the time-consuming dissolving, boiling and cooling of the sugar associated therewith is no longer necessary. Also, the use of the known starch molding trays and the related time expenditure (beating and dusting of the molded pieces) is facilitated thereby or even omitted completely. With this process, a simplified production process is provided, which offers a significant advantage in safety, energy consumption, time expenditure, and raw materials.

### DETAILED DESCRIPTION OF THE INVENTION

The term “gelatin-containing confectionery” in the context of the present invention refers to products (confectionery products) having a significant content of gelatin (>x % by weight, based on the total mass of the product) for shaping and stabilization. They may be transparent or colored throughout.

“Thickening agent” means gelatin, alginate, agar (E 406).

“Starch flour” (or “fecula”) is a fine white powder usually employed for thickening foods. Upon cooking, it becomes glassy and transparent and is tasteless. Under the action of heat, starch can physically bind many times its own weight of water, swell and gelatinize. When heated with water, the starch will swell at 47-57° C., the layers burst, and at 55-87° C. (at 62.5° C. for potato starch, at 67.5° C. for wheat starch), starch paste is formed, having a variable gelling ability depending on the type of starch. Gelatinized starch and coagulated gluten form the base structure of all kinds of pastries. Starch swells not so much when heated, but predominantly during cooling. The most important starch sources for thickening agents include cereals, especially wheat, rice and corn, potatoes, tapioca, sago, arrowroot and soybean. Corn starch, which is the most frequently used starch, is mainly used for sweet sauces, custards and Asian foods. Potato starch is versatile and binds liquids far below their boiling points. Tapioca, which is the starch from the roots of the cassava shrub, and sago, an extract from the pith of the true sago palm, are also used for thickening gravies, fruit sauces, custard and porridge. Arrowroot is employed in fruit jellies, sauces and desserts. Like flour, starch is usually mixed always in cold liquid, added to the boiling food with constant stirring, and then boiled for about 2 minutes, after which it is removed from the heat.

“Sugar substitutes” are sweet tasting carbohydrates that have no influence on the blood glucose level. They have an energy content of at most 2.4 kcal/g (which corresponds to the EU limit). Therefore, they are used in dietetic foods and are also employed in toothpaste, dental care chewing gums etc. because they have no cariogenic effect. Their sweetening power is similar to that of sucrose. They are mostly obtained from fruits or vegetables. Sugar substitutes include various sugar alcohols (sorbitol, mannitol, isomalt, maltitol, maltitol syrup, lactitol, xylitol) and fructose. In the context of the present invention, isomalt, maltitol (E 965), maltitol syrup and fructose are the preferred sugar substitutes, and maltitol and the sugar substitutes that can be produced from maltitol, especially maltitol syrup and isomalt, are particularly preferred.

“Syrup” is a viscous concentrated solution of a sugar or sugar substitute obtained by boiling down or other techniques, especially by enzymatic cleaving processes, from sugar-containing liquids, such as sugar water, liquids containing sugar substitutes, sugar beet juice, fruit juices or plant extracts. Because of its high sugar content, it can be kept for long periods without refrigeration. Syrup within the meaning of the present invention includes glucose syrup, fructose syrup and maltitol syrup. Syrup within the meaning of the present application explicitly does not include syrup-like substances, such as maple syrup and honey.

The terms “syrup containing a sugar substitute” and “sugar substitute syrup” are used interchangeably in the following. They refer to a syrup which either is itself a sugar substitute (such as maltitol syrup) and/or contains a sugar substitute (such as isomalt syrup or maltitol syrup).

In the context of the present invention, a “hexose syrup” is a syrup that contains hexose sugar (mono- or oligosaccharide) as its main component. Preferably, it is glucose syrup or fructose syrup, or a mixture of these two syrups. Glucose syrup is even more preferred. If the base material according to the invention is to be suitable for a dietetic food or feedstuff, the syrup is preferably maltitol syrup or isomalt syrup.

“Glucose syrup” is a concentrated solution obtained from starch by enzymatic cleavage, which contains a mixture of different mono- and oligosaccharides. One of its main components is glucose (grape sugar). In addition to glucose as a monosaccharide, glucose syrup frequently also contains high amounts of maltose, maltotriose and oligosaccharides (e.g., Grafschafter glucose syrup 43° or 45°. Glucose syrup is predominantly used in industrial food production for sweetening foods and beverages. This is why this syrup is one of the most important products of starch industry. Because of the enzymatic cleavage of starch, sweet sugars can be obtained not only from sugarcane and sugar beets, but also from more economic plants, such as corn, potatoes and wheat, which today is performed on an industrial scale in the process of starch saccharification. Many foods, such as candies, cannot be prepared without an addition of glucose syrup, because glucose syrup prevents the crystallization of beet sugar (sucrose) in the production of hard caramels, prolongs the fresh keeping of soft caramels, fondant, gummi candy and aerated confectionery, is an ingredient of non-alcoholic soft drinks, liqueurs, ice cream, jams, fruit jellies, is employed as a sweetening and browning agents for bakery products, and is contained in muesli, salad dressings and fruit powders. Glucose syrup has a neutral to sweet taste and is readily soluble in water.

“Fructose syrup” is a clear light-colored syrup having an unpleasantly intense sweet taste whose sugar content (usually 70% by weight) consists of at least 90%, mostly at least 95%, fructose (balance: usually glucose).

“Maltitol syrup” (E 965 (ii)) consists of maltitol, sorbitol and hardened glucose syrup. Isomalt syrup consists of isomalt (E 953) and water and is usually prepared by boiling isomalt in water. Both syrups are sugar substitutes (food sweeteners) and are used for the preparation of dietetic foods or feedstuffs. In particular, maltitol syrup serves as a food additive for juices, marzipan and chewing gums. Isomalt is preferably employed in desserts, ice cream and confectionery.

Lecithin (chemical designation: phosphatidylcholine) is usually a powder in its commercial form. It is used in the food, pharmaceutical and cosmetics industries as an emulsifier for stabilizing fat-in-water mixtures.

In the context of the present application, “homogeneous mass” means that all components of a mixture are uniformly distributed in this mixture. Thus, a homogeneous mass within this meaning may also have heterogeneous components, i.e., be a suspension or a mixture of syrup and particles of different sizes, for example.

A “conventional flour” (also referred to as “flour” in the following) is not a starch flour (powder), but a classical cereal flour, such as wheat or rye flour. Flour is formed by grinding cereal grains. It consists of starch, protein (in wheat flour: gluten), cellulose (roughage) and water.

The base material according to the present invention “essentially” consists of the starch flour and syrup as defined above, and is obtained by mixing or kneading the components together. “Essentially” means that the base material, in addition to these two components, may contain further components that give a homogeneous mixture with the base material, but only in insignificant proportions. The proportion of such further miscible components is at most 10% by weight, preferably at most 1.0% by weight (based on the base material). The further components may include any substances used for foods. However, fats, oil or other lipid-containing components should not be among such further components, if possible. Rather, said further components are preferably functional components that provide the material with a specific appearance, a specific smell and/or a specific taste, i.e., they are preferably flavorants including perfumes and flavoring agents, stabilizers (such as glycerol) and/or colorants.

In addition, the base material may also contain immiscible, i.e., dispersible, substances, such as grains, fruits etc. The proportion of the base material may be up to 50% by weight (based on the base material).

Most preferably, the base material according to the invention consists exclusively of the starch flour and the syrup, i.e., it contains no further components at all.

Both the starch flour employed and the syrup employed may be mixtures of several types of starch flour or syrups, respectively. However, the use of only one starch flour (e.g., only one starch type, especially corn starch) and only one type of syrup (preferably only glucose syrup) is preferred in the base material according to the invention.

The weight ratio of powder to syrup in the base material of the process according to the invention is preferably from 1:0.5 to 1:1, more preferably from 1:0.6 to 1:0.9. Based on 100 g of powder, this means a proportion of preferably 50 g to 100 g of syrup, more preferably 60 g to 90 g of syrup. In particular, the mixture of 100 g of powder and 80 g of syrup is optimally suitable as a base mass for further uses, and is therefore most preferred.

In a preferred aspect of the process according to the invention, said starch flour is corn starch, potato starch, wheat starch, rice starch or soy starch. In addition, in this preferred aspect, said syrup is preferably glucose syrup. The latter combination (glucose syrup plus starch flour) has the advantage that it is immediately consumable and can be consumed in a cold state.

If the powder is a mixture of several starch flours, it is preferred that starch flour is the main component of the mixture (i.e., its proportion is above 50% by weight, preferably above 80% by weight, more preferably above 95% by weight). In another preferred aspect of the process according to the invention, the syrup is a hexose syrup, preferably glucose or fructose syrup, or a mixture of these two syrups, more preferably glucose syrup. The latter is able to bind all the mentioned starch flours including soy flour, thickening agents and lecithin.

If the syrup is fructose syrup, the powder is preferably not starch flour, but one of the other thickening agents mentioned above, or lecithin.

Among all sugar-containing syrups, glucose syrup is most preferred for the present invention.

In yet another preferred aspect of the process according to the invention, the syrup is a sugar substitute syrup, because the base material becomes dietetic thereby. If the syrup is a sugar substitute syrup, isomalt syrup and maltitol syrup are most preferred. In such a case, the powder is preferably starch flour.

The use of a sugar substitute syrup in the base material according to the invention suggests itself, in particular, in all cases where the base material is to be used for dietetic products, especially for dietetic foods or feedstuffs.

The following aspects of the process according to the invention are even more preferred: starch flour with glucose syrup, lecithin powder with glucose syrup, a mixture of starch flour, lecithin and one or more other thickening agents with glucose syrup and guar gum with fructose syrup. Starch flour with glucose syrup is most preferred.

In the syrup for the process according to the invention, the content of dry matter is preferably from 65 to 85%, more preferably from 70 to 80%. This dry matter is essentially constituted by sugars or sugar substitutes. Thus, glucose syrup usually contains from 79 to 82% of dry matter, which in turn consists of from 15 to 19% of glucose, from 11.5 to 15.5% of maltose, from 11 to 14% of trioses, and from 51 to 62.5% of oligo-/polysaccharides. In maltitol syrup, usually at least 50%, preferably at least 70%, of the dry matter is maltitol. Even more preferably, commercially available syrups are used for the base material.

The base material used in the process according to the invention is a homogeneous mass. It may have any consistency from completely solid to deformable, to pasty, to liquid. The hardness can be adjusted, namely by the selected ratio of powder to syrup. In a preferred aspect, the material is solid, but deformable, i.e., it has about the consistency of clay or raw marzipan.

In a preferred aspect, the base material contains, in addition to the powder and the syrup, another functional component that is completely miscible with the base material, in a proportion of from 0 to 10% by weight, preferably from 0 to 0.1% by weight (based on the base material). This corresponds to at most a few drops of a liquid flavoring agent or colorant per 100 g of base material. Such functional components provide the material with a specific appearance, a specific smell and/or a specific taste, i.e., they are preferably flavorants including perfumes and flavoring agents, and/or colorants. In addition, the base material may also contain immiscible components, such as grains and fruits, i.e., at up to 50% by weight (based on the base material).

The base material is liquefied at a very low temperature, which nevertheless has to be high enough to keep it fluid (pourable/castable). The liquefaction is preferably effected at below 60° C., especially at 40 to 50° C. The addition of gelatin in step (b) is performed within the same temperature range. The cooling in the process according to the invention may be effected in molds (starch molding trays).

In a preferred embodiment, the process is employed to prepare wine gums. Components of the novel fruit gum mass are:

(1) Potato starch (other starches are also possible)

(2) Glucose syrup

(3) Commercially available gelatin

(4) Glycerol as a softening agent

(5) and all approved colorants and flavoring agents.

In another embodiment, the confectionery is energy balls, soft caramels or filled chocolate candies.

The invention is illustrated by means of the following Examples, which are not, however, to be construed as limitative to the subject matter of the invention.

### EXAMPLES

### Example 1

Composition with caramel-like consistency, “base material”

At room temperature, 100 g of corn starch was kneaded manually with 80 g Grafschafter® glucose syrup (“glucose syrup” in the following) until a homogeneous mass was formed. The result was a homogeneous tough mass (referred to as “base material” in the following) having a consistency similar to that of soft caramels (such as Storck Riesen®). This mixture is stable for at least 6 months.

In an analogous way, potato, wheat or rice starch was used instead of corn starch. The result was similar to that achieved with corn starch.

The glucose syrup employed was Grafschafter glucose syrup 43°; composition according to the manufacturer's specifications:

Dry matter: 79.0-80.0%

Sugar spectrum in dry matter:

| | |
|---|---|
| Glucose (dextrose) | 15.0-19.0% |
| Maltose | 11.5-15.5% |
| Maltotriose | 11.0-14.0% |
| Oligo-/polysaccharides | 51.5-62.5% |

### Example 2

Preparation guide for the fruit gum articles with gelatin

Formulation:

1.) 100 g of glucose syrup

2.) 80 g of potato starch

3.) 6-8 tablespoonfuls of gelatin (one tablespoonful of dissolved gelatin =10 g)

4.) a pinch of glycerol

5.) colorants and flavoring agents

Instruction for preparing the mass: Components (1), (2), (3), (4) and (5) are mixed together at normal room temperature and kneaded until a homogeneous mass or dough is obtained. Gelatin is dissolved according to instructions and heated at 70-80° C. The prepared mass is heated at 40-50° C. with stirring, dissolved (spreadable). After cooling the gelatin to 40-50° C., the mass is added with stirring until both are homogeneously compounded together (a few drops or tablespoonfuls of warm water may be added in order to obtain better castability), and the mass obtained is cast into the prepared molds. The otherwise common negative mold starch trays can be dispensed with. Any molds desired may be employed.

Because of the stable performance of the mass, it is also possible to cut it, punch it or shape it by rolling it out, instead of casting it into molds.

The mass is dimensionally stable and can be released from the molds in about 30 minutes. Thus, a continuous production is possible from casting to packaging without interruption (congealing time).

In further experiments, potato, wheat or rice starch was used instead of corn starch. The result was similar to those achieved with corn starch.

### Example 3

Preparation guide for energy balls, soft caramels and filled chocolate candies

Formulation:

1.) 100 g of glucose syrup

2.) 80 g of corn starch (or other starches)

3.) 10-15 g of butter (or other fats)

4.) 10-20 g of powdered milk

5.) 5-10 g of lecithin

6.) 50-70 g of any mixture of grains

7.) half a teaspoonful of glycerol

8.) colorants and flavoring agents

9.) 20-30 g of dissolved gelatin (or similar thickening agents)

Instruction for preparing the energy ball mass: (1) to (8) are mixed together and kneaded until a homogeneous mass or dough is obtained. The dissolved gelatin is cooled down to about 30-40° C. and kneaded together with said mass or dough.

The mass can be further processed immediately into the desired final product. Balls, strips or any other shapes can be prepared.

If the mixture of grains is omitted from the mass, a new and completely different product, such as the mentioned soft caramels and filled chocolate candies, can be prepared with the same formulation and method.

The base material is prepared at room temperature. Industrial advantages include savings of energy and time, reduction of the raw materials; no addition of sugar and no associated energy expenditure of boiling and subsequent cooling; no preservatives.

If the further processing via the base material is to be performed at a later time, the butter or other fat as well as the gelatin can be mixed with the base material at said desired time.

1. A process for the production of gelatin-containing confectionery, comprising the steps of:
(a) liquefying a base material essentially consisting of a starch flour or a mixture of several starch flours and a syrup or a mixture of several syrups, by heating at a temperature of below 60° C.;
(b) adding a heated and liquefied gelatin and mixing it with the liquefied base material obtained in step (a); and
(c) cooling the mixture obtained to solidify.

2. The process according to claim 1, wherein said starch flour is corn starch, wheat starch, rice starch, soy starch or potato starch.

3. The process according to claim 1, wherein said syrup is a hexose syrup, or a sugar substitute containing syrup.

4. The process according claim 1, wherein the weight ratio of the starch flour to the syrup is from 1:0.5 to 1:1.

5. The process according to claim 1, wherein said base material contains, in addition to the syrup and starch flour, from 0 to 10% by weight of a functional component that is miscible with the base material.

6. The process according to claim 1, wherein said base material contains up to 50% by weight of components that are immiscible with the base material.

7. The process according to claim 1, wherein said gelatin is a gelatin obtained from pigs or cows or a thickening agent derived from algae, and the content of gelatin is from 10 to 35% by weight (based on the confectionery).

8. The process according to claim 1, wherein the liquefaction in step (a) is effected at a temperature of 40 to 50° C.

9. The process according to claim 1, wherein said adding of the gelatin in step (b) and said mixing are effected within the same temperature range.

10. The process according to claim 1, wherein said process further comprises the preparation of the base material, which is effected by mixing and kneading said starch flour or said mixture of starch flours with said syrup or said mixture of syrups and optionally said further functional components.

11. The process according to claim 1, wherein said confectionery is fruit gums, and wherein said base material consists of potato starch, glucose syrup, glycerol, colorants and flavoring agents.

12. The process according to claim 1, wherein said confectionery is energy balls.

13. The process according to claim 1, wherein said confectionery is soft caramels or filled chocolate candies.
